(19) United States
(12) Patent Application Publication
(10) Pub. No.: US 2018/0225409 A1
(43) Pub. Date: Aug. 9, 2018

(54) PERFORMANCE ANALYSIS AND MONITORING OF RADIAL TURBOMACHINERY

(71) Applicant: Charles C. Solvason, College Station, TX (US)

(72) Inventor: Charles C. Solvason, College Station, TX (US)

(21) Appl. No.: 15/943,575

(22) Filed: Apr. 2, 2018

Related U.S. Application Data
(63) Continuation-in-part of application No. 14/295,071, filed on Jun. 3, 2014.
(60) Provisional application No. 61/927,256, filed on Jan. 14, 2014.

(51) Int. Cl. G06F 17/50

(52) U.S. Cl. CPC G06F 17/5086; G06F 17/5009

(57) ABSTRACT

A method of analysis of turbo-machinery that is used in control, monitoring and analysis of turbo-machinery; in improving the operation of a computer system running programs programmed to calculate, inter alia, turbomachinery operation parameters and performance; and which novel approach may be expressed in machine readable language and disposed on non-transitory machine-readable media. The method allows (1) a real-time performance monitoring a computer implemented applications that communicates with Process Simulation (CPS) systems and process plant information (PI) systems describing turbo-machinery equipment performance at design and off-design operating conditions.

### CROSS REFERENCE TO RELATED APPLICATIONS

This application is a Continuation-in-Part of U.S. Ser. No. 14/295,071 filed Jun. 3, 2014, which application claims benefit of Provisional Application Ser. No. 61/927,256 filed Jan. 14, 2014, the content, Figures and disclosure of which are incorporated herein by reference in their entirety for all purposes.

### FIELD OF THE INVENTION

The invention relates to processes for monitoring performance and control of turbo-machinery and for improving the efficiency and performance of computer systems operating on programs for turbo-machinery control and performance evaluation.

### BACKGROUND

The performance of radial turbo-machinery is typically described by equipment performance curves or limited empirical models provided by the equipment manufacturer. The performance curves are developed from the design operating conditions and are utilized to determine the optimum process set points needed to maximize a set of performance indicators. Typical process set points may include the shaft speed, flow rate, and/or power of the equipment while typical performance indicators may include efficiency, head, power, etc.

Although the performance curves can reasonably estimate performance for a variety of set points, they are dependent upon inlet stream conditions at or near the design point. This limitation can significantly hinder the ability of manufacturers to maximize the performance of their equipment, process, plant, and/or network. Furthermore, mechanical deterioration such as fouling or vane deformation can alter the designed geometry of equipment, thereby reducing its performance at all process conditions. Mechanical deterioration may be addressed with solvent washes and/or physical replacement of the affected part, both of which require the process to be taken out of service, resulting in sub-optimal performance. The cumulative nature of mechanical deterioration requires continuous monitoring to detect events and knowledge of equipment performance capability at off-design process conditions.

### SUMMARY

The present invention is a novel approach to the analysis of turbo-machinery that can be used in control, monitoring and analysis of turbo-machinery; in improving the operation of a computer system running programs programmed to calculate, inter alia, turbomachinery operation parameters and performance; and which novel approach may be expressed in machine readable language and disposed on non-transitory machine-readable media.

An important aspect of the invention is a process for (1) a real-time performance monitoring a computer implemented applications that communicates with Chemical Process Simulation (CPS) systems (such as ProMax® from Bryan Research and Engineering of Bryan, Tex., Aspen PIus™ and HYSYS™) and process plant information systems ((PI systems such as OSIsoft's Plant Information (PI) system)) and (2) a set of calculated turbo-machinery performance models capable of describing equipment performance at design and off-design operating conditions.

Benefits of the processes of the invention for, for example, gas plants include (1) the real time determination of phase properties, compositions, and physical property limits, such as, for example, hydrate formation temperatures of all streams in a modeled system, (2) the monitoring of performance measures for turbo-machinery equipment, such as fouling, wear of component parts, damage and other turbo-machinery performance metrics, and (3) analysis and optimization of process systems containing radial turbo-machinery.

### DESCRIPTION OF FIGURES

The Figures represent embodiments and aspects of the invention and are not intended to be limiting of the scope of the invention.

FIG. 1 is a flowchart of an overview of the model development procedure of an embodiment of the invention.

FIG. 2 is a schematic representation of inward flow radial turbine stages and process stream states.

FIG. 3 is an illustration of velocity triangles for an inward flow radial turbine.

FIG. 4 is a schematic representation of centrifugal compressor stages and process stream states.

FIG. 5 is a graphical illustration of velocity triangles for a centrifugal compressor.

FIG. 6 is a flowchart of an overview of the plant information application flow.

FIG. 7 is a graphical illustration of the results of a case study highlighting the predicted aMoB+ model set results against the actual data historian results as calculated by the CPS.

FIG. 8 is a graphical illustration of the results of a case study highlighting the predicted BPT model results against the actual results as calculated by the aMoB+ model set.

### DETAILED DESCRIPTION

The invention, in broad aspect, is expressed in three embodiments: 1) a computer software system that improves the operation, accuracy and efficiency of computer system that is programmed to calculate, inter alia, operating parameters and performance of turbo-machinery, where efficiency (η), head (H), and work (\dot{W}), are used as performance indicators and computer system that is programmed to provide process information (PI systems); 2) processes to evaluate turbo-machinery equipment performance to provide a real-time monitoring system for equipment performance and means for analysis and control; and 3) articles of manufacture consisting of a software program disposed on non-transitory machine-readable media.

Actual turbomachinery parameters and performance are determined from the solution of the continuity equations for mass, energy, and entropy, thermodynamic property models, and user-defined physical states of process streams. Performance is calculated from the performance function (ƒ), which is derived from the basic parameters that influence the performance of turbomachinery: wheel tip diameter (D), shaft speed (N), mass flow rate (\dot{m}), molecular weight (M), heat capacity ratio (γ), viscosity (μ), and the pressure (P) and temperatures (T) of the streams entering and exiting the turbo-machinery. See Dixson, S. L., Fluid Mechanics, Thermodynamics of Turbomachinery; Forth Edition; Butterworth-Heinemann, Woburn, Ma. 1998, herein referred to as Dixon, 1998.

ƒ(D,N,\dot{m},P,T,R,γ,μ)=0 (1)

Using the mass balance, energy balance, entropy balance, thermodynamic property models, user-defined physical states of process streams, and the Angular Momentum Balance (aMoB) the performance function of Eq. 1 can be satisfied. Of these, only the aMoB is seldom found in CPS systems. The aMoB is based on the equation of motion of an inviscid, Newtonian fluid, integrated over the control volume. Since the flow of a compressible fluid around airfoils, such as those in rotors and stators, is inviscid, any shear forces creating viscous work are contributed solely to the machine, resulting in the aMoB model for radial turbomachinery in Eq. 2:

$$τ = \sum ( \overline{r} \times \overline{F} ) = \frac{d}{dt} {\int }^{cv} ( \overline{r} \times \overline{ρ} \overline{C} ) dV + {\int }^{cs} ( \overline{r} \times \overline{ρ} \overline{C} ) ( \overline{C} \cdot \overline{n} ) dA \qquad ( 2 )$$

where r̅ is the vector of radii, F̅ is the vector of the fluid forces on the mechanical body at the control surface (cs), cv is the control volume, C̅ is the vector of velocities, ρ̅ is the vector of fluid densities, n̅ is the normal vector, and A is the control surface area.

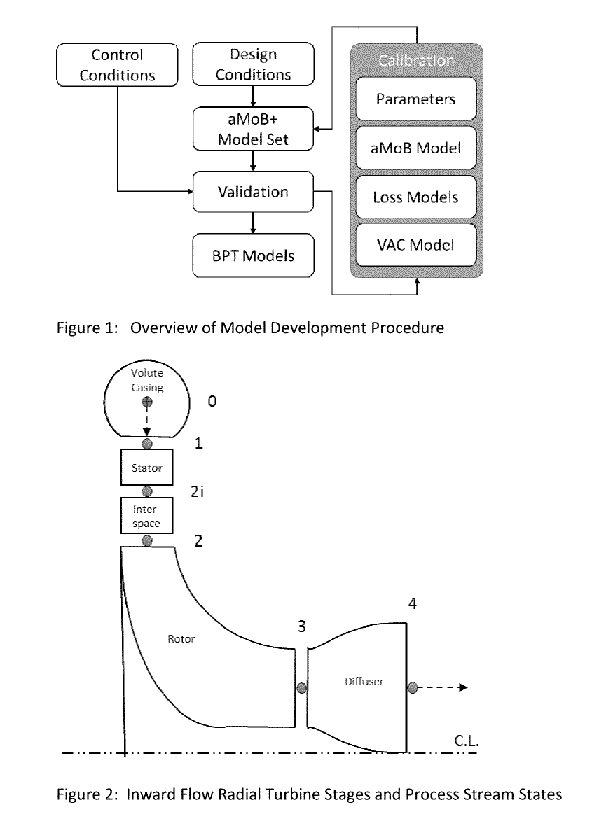

The principal feature of the present invention is a system for calculating the actual performance of specific turbo-machines from specified input data. This allows the monitoring and control of the turbo-machines. The system is designated herein as the “Turbo-machine BPT Model”. The procedure for developing a Turbo-machine BPT model with an explicit set of expressions satisfying a aMoB model (as defined herein) is shown in FIG. 1 and involves the following steps:
a) obtain equipment and process design specifications;
b) use design specifications to build an aMoB model of the system;
c) use the aMoB model to develop the parameters for the BPT model;
d) using a design of experiments approach, fit the BPT model against a control set of data from a real or virtual machine;
e) add or adjust the vane angle control model and loss models to the aMoB model to create a aMoB+ model;
f) refit the BPT model to the aMoB+ model;
g) repeat steps 4-6 until a satisfactory model is created;
h) use the BPT model to provide monitoring for performance; or
i) alternatively, use the BPT model to provide control of the stator or impeller vanes, by updating the angle calculated in the VAC model to account for fouling.

The following information is required to develop these parameters.
1. Expander and compressor efficiency, head, and power curves.
2. Process flow diagram (PFD) showing flows, compositions, and thermodynamic properties of the streams entering and exiting the radial turbo-machinery.
3. Vane angle control scheme
4. Stator vane angle α₂ᵢ at 50% open
5. Vane area at full open
6. Number of stator vanes
7. Rotor blade angle β₃ at the hub and shroud
8. Diameters at the wheel tip, hub, and shroud.
9. Equation of State used to create the design curves

It should be noted that while the aMoB+ model would be more accurate than the Turbo-machine BPT model, its implicit nature means that it is not as robust as the Turbo-machine BPT model, making it not suitable for use in either a monitoring or control scenario. The details of these calculations and models outlined in FIG. 1 are described below. As used herein and in the claims the following definition apply:

“aMoB Model” means the collection of the implicit, integral form of the mass balance (MB), energy balance (EB), and angular momentum balance (AMB) models described by Equations

$$MB \text{:} \frac{d}{dt} {\int }^{cv} ρ dV + {\int }^{cs} ρ ( \overline{C} \cdot \overline{n} ) dA = 0$$

$$EB \text{:} \dot{Q} - \dot{W} = \frac{d}{dt} {\int }^{cv} \hat{e} \cdot ρ dV + {\int }^{cs} ( \hat{e} + \frac{P}{ρ} ) ρ ( \overline{C} \cdot \overline{n} ) dA$$

$$AMB \text{:} \sum ( \overline{r} \times \overline{F} ) = \frac{d}{dt} {\int }^{cv} ( \overline{r} \times \overline{C} ) ρ dV + {\int }^{cs} ( \overline{r} \times \overline{C} ) ρ ( \overline{C} \cdot \overline{n} ) dA = τ$$

“VAC Model” means the representative turbo-machine vane's angle control.
“Loss Models” means the representative empirical expressions used to model different loss mechanisms that lead to isentropic efficiency losses of enthalpy.
“aMoB+ Model Set” means the collection of the implicit aMoB set of models, with the addition of the VAC models and Loss Models.
“Parameters” means the set of parameters utilized in the aMoB+ model set.
“BPT Models” means the empirical, explicit expressions derived using the Buckingham n theorem of dimensional analysis to fit the result of the aMoB+ models.
“Design Conditions” means the set of equipment and process design measurements from the original construction of the turbomachinery and corresponding flows.
“Control Conditions” means a set of near-design measurements taken from the process equipment where the machinery can be considered operating in a normal state.
“Validation” means calculating the residual performance between the aMoB+ model set and the control condition measurements.

The aMoB model set is commonly applied to two types of radial turbomachinery, inward flow radial turbines and centrifugal compressors. The development of the aMoB model set into a set of implicit expressions is presented in the next sections.

The first set of embodiments of the invention is a software system (Turbo-machine BPT model as described above) expressed in machine readable language and disposed on non-transitory machine-readable media that improves the operation of a computer system running programs programmed to calculate, inter alia, turbomachinery operation parameters and performance (Process Modeling programs) and machines programmed to process and display process information (PI systems). The system performs the process steps outlined above for a Turbo-machine BPT model.

The second set of embodiments of the invention are methods for monitoring and control of turbo-machines. Exemplary of such method(s) are a process that utilize a computer system for calculating operating parameters for operating turbo-machines (Process Modeling program) and machines programmed to process and display process information (PI systems program). In this embodiment a computer system running either or Process Modeling programs or PI systems will have a Turbo-machine BPT model incorporated to monitor the performance of the turbo-machine. A PI system convers performance data in various formats (sensor data, manually input data, stored historical data and the like) into a common format that is then manipulated for analysis and display oft for connection to activators and includes storage for selected historical data (data historian). The incorporation of Turbo-machine BPT model into the PI system greatly increases its accuracy and efficiency in monitoring turbo-machinery performance and control. The performance and operation parameters can be displayed or otherwise accessed in real time to allow determination of decline of performance thus allowing adjustment of operation parameters, cleaning maintenance, repair or replacement base on predetermined criteria. The real time performance result may also be configured to control activators to automatically control operating parameter or to provide alarms, or other notification of unwanted performance factors. Turbo-machinery operating parameters include, inter alia, liquid and gas flow rates, temperature and pressure. These are generally controlled by automated control valves and other means.

The third set of embodiments of the invention comprise article(s) of manufacture consisting of a machine-readable software program(s) implementing the Turbo-machine BPT model (as described above) disposed on non-transitory machine-readable media. Machine readable non-transitory media includes computer hard drive (mechanical and solid state), flash drives, computer disks (CDs), DVDs and other media capable of storing computer instructions in a manner that can be accessed by a computer system.

### Detailed Description of Development and Testing of the Turbo-Machine BPT Models

### Radial Turbine Models

In order to apply Eq. 2 to a radial turbine, the system must be expanded to detail the radial lengths used in the machine, resulting in 5 major stages and 6 physical process stream states as shown in FIG. 2. The fluid enters the turbine at state 0 from the volute casing before hitting the stator at state 1. Typically, this change in state is small and neglected (Dixon, 1998). A change in state from 1-2i occurs in the stator where the flow is accelerated. The change in state can be described using the expression for the efficiency (η_{N}). Any irreversible work lost can be described using an efficiency model based on static enthalpy loss in the nozzle (ξ_{N}).

$${η}_{N} = \frac{{C}_{2 i}^{2}}{{C}_{2 is}^{2}} = \frac{1}{( 1 + {ξ}_{N} )} \qquad ( 3 )$$

The loss term has only a marginal impact on the overall efficiency and is generally considered to be constant between 0.05 and 0.1. In some cases, a dynamic loss is proposed, which can be characterized using an empirical model.

$${ξ}_{N} = \frac{0.05}{{Re}_{{v}_{b}}^{0.2}} ( \frac{3 cot {α}_{2 i}}{{v}_{s} / {v}_{c}} + \frac{{v}_{s} sin {α}_{2 i}}{{v}_{b}} ) \qquad ( 4 )$$

where Re_{b} is the Reynolds number using the characteristic vane length (v_{b}), α₂ᵢ is the incidence angle at the exit of the stator, vₛ is the vane spacing, v_{c} is the vane chord length.

Between the stator and the rotor, an uncontrolled expansion occurs in the interspace and the state changes from 2i to 2. This expansion is modeled as a vaneless nozzle where the exiting incidence angle (α₂) can be estimated by applying free vortex constraints to the mass balance.

$$tan ( {α}_{2} ) = tan ( {α}_{2 i} ) ( \frac{{ρ}_{2}}{{ρ}_{2 i}} ) ( \frac{{d}_{2 i}}{{d}_{2}} ) ( \frac{{A}_{2}}{{A}_{2 i}} ) \qquad ( 5 )$$

where ρ₂ᵢ and ρ₂, d₂ᵢ and d₂, A₂ᵢ and A₂ are the densities, diameters and areas of the fluid at states 2i and 2, respectively.

The fluid then enters the rotor in a radial direction, expands, and exits along its axis, turning the rotor and generating shaft work (\dot{W}) during the process. In most cases, the Eq. 2 reduces to Euler's turbo-machinery balance.

\dot{W}=\dot{m}(U₂C_{θ2}−U₃C_{θ3}) (6)

where \dot{m} is the mass flow rate of the fluid, U₂ is the wheel tip velocity, C_{θ2} is the fluid velocity in the tangential direction at the wheel tip, U₃ is the geometric mean square of the velocity of the shroud and hub, C_{θ3} is the fluid velocity in the tangential direction at the geometric mean square diameter (d₃). The change in state between state 2 and state 3 can be described using the expression for the efficiency (η_{R}). Any irreversible work lost can be described using a model based on static enthalpy loss in the rotor (ξ_{R}).

$${η}_{R} = \frac{\dot{W}}{{\dot{W}}_{s}} = \frac{\dot{W}}{\dot{W} + {ξ}_{R} {w}_{3}^{2} + \frac{{C}_{3}^{2}}{2} - \frac{{C}_{3 s}^{2}}{2}} \qquad ( 7 )$$

where η_{R} is the rotor efficiency, w₃² is the relative velocity, and fluid axial fluid velocities at the actual C₃ and isentropic C₃ₛ velocities. The rotor enthalpy loss (ξ_{R}) is dynamic and is typically estimated as a summation of incidence (ξ_{I}), passage (ξ_{P}), clearance (ξ_{CL}), and trailing edge losses (ξ_{TE}).

ξ_{R}=ξ_{I}+ξ_{P}+ξ_{CL}+ξ_{TE} (8)

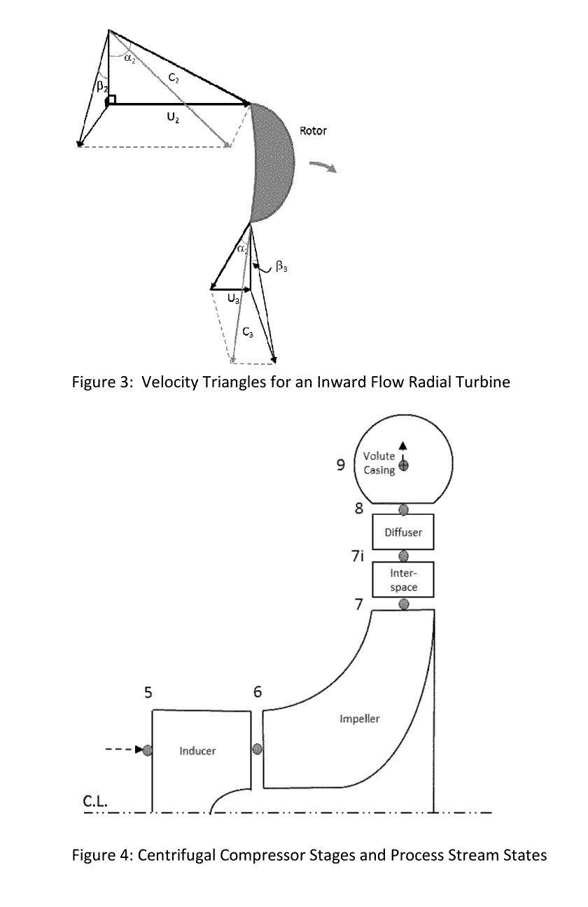

Empirical representations of these losses can be gathered from literature (Dixon, 1998) and are generally dependent upon the velocity vectors depicted in FIG. 3 and other geometric specific parameters.

Finally, the flow is slowed in the diffuser and the state changes from 3 to 4. The diffuser is modeled as a vaneless nozzle and the enthalpy loss (ξ_{D}) can be estimated using an empirical model. (Dixon, 1998).

$${ξ}_{D} = \frac{0.375 {d}_{3}}{{Re}_{{d}_{3}}^{0.2} {b}_{3} sin {α}_{3}} ( 1 - {( \frac{{d}_{3}}{{d}_{4}} )}^{1.5} ) {( \frac{{C}_{3}}{{U}_{3}} )}^{2} \qquad ( 9 )$$

where Re_{d}_{₃} is the Reynolds number using the diameter at state 3 (d₃), d₄ is the diameter at state 4, α₃ is the incidence angle at the exit of the rotor, and b₃ is the vane length. The typical solution to the set of implicit models described by Eq. 3-9 plus the set of mass, energy, and entropy balances is to utilize the characteristic geometry of the system, the design conditions of state 1, and the shaft speed (N) to estimate the velocity vectors, enthalpy losses, and performance indicators. For fixed geometries with near-constant physical properties of state 1, such an approach is acceptable and often used to generate a set of representative performance curves.

Similarly, equipment manufacturers also apply this approach to varying geometries by incorporating a variable geometry model (VGM) as function of measurable physical properties, such as the mass flow rate (\dot{m}). However, the addition of the VGM based on measurable physical properties is not sufficient to accurately model the system which may lead to poor data reconciliation at off-design conditions.

This application embodiment utilizes a novel vane-angle control (VAC) model in place of the VGM. The VAC model is developed by using the equipment manufacturer's existing performance curves as inputs to a representative aMoB model set developed from Eq. 3-9, to solve for the stator vane angle (α₂ᵢ). The stator vane angles are then fit against a set of fluid properties at the design conditions of state 1 to develop the model. The primary benefit of the approach is that the dependent variables in the resulting VAC model need not be measurable, a factor which provides an opportunity to use variables that more closely align with the underlying physics of the equipment. The end result is a VAC model that can accurately describe off-design geometry behavior.

The VAC model is then combined with the aMoB model set to create the aMoB⁺ model set. The set of aMoB⁺ models is then validated against operating data from a control available from the chemical processor. Differences between the aMoB⁺ model and the control are addressed by adjusting the negligible or slightly negative rotation (≥−30°) entering the rotor, adjusting the negligible or positive rotation at the exit, and applying enthalpy loss models such as those described in Equations 4, 7, and 9.

### Centrifugal Compressor Models

In order to apply Eq. 2 to a compressor, the system must be expanded to detail the radial lengths used in the machine, resulting in 5 major stages and 6 physical process stream states as shown in FIG. 4.

A fluid entering the compressor at state 5 first encounters the inducer on the impeller and is funneled into the annulus just before meeting the impeller blades. This change can be modeled as a nozzle using the expressions derived in the previous section but is often considered to be negligible. The fluid then enters the impeller in the axial direction at state 6, is compressed by the impeller as it turns, and exits in the radial direction at state 7i. Applying the momentum balance results in

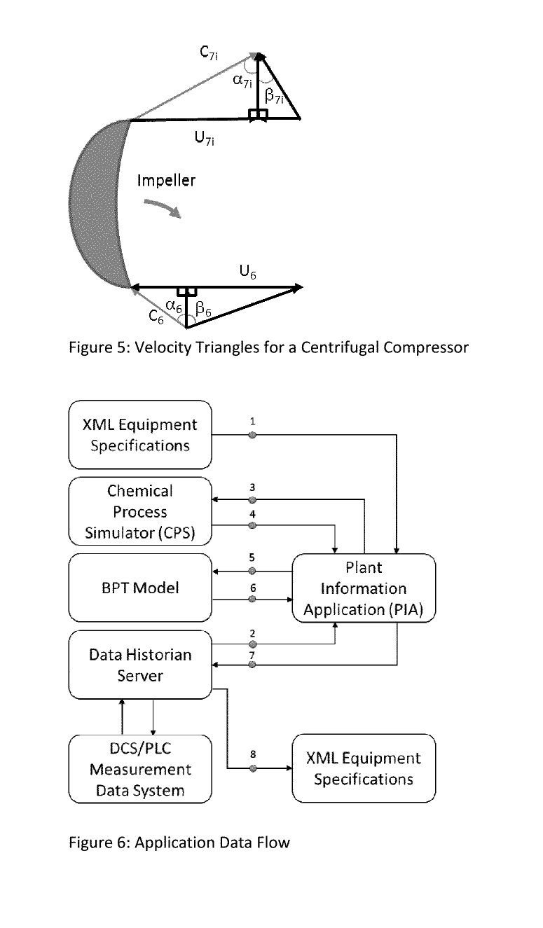

\dot{W}=\dot{m}(U₇ᵢC_{θ7i}−U₆C_{θ6}) (10)

Where C_{θ6} is the component of the incoming velocity in the radial direction, C_{θ7i} is the exit velocity component is the radial direction, U₆ is the geometric mean square of the impeller velocity at the shroud and hub, and U₇ᵢ is the wheel tip velocity. The velocity triangles are shown from an axial view in FIG. 5. The entering velocity is a function of the pre-whirl vane angle α₆ and the exiting velocity is dependent upon the vane angle of the impeller α₇ᵢ, minus the backward swept blade angle, β₇ᵢ.

In practice, the flow cannot be perfectly guided, so it is said to slip, leading to modified velocity triangles and ultimately resulting in an impeller that must run at higher speeds in order to deliver the required pressure ratio (Dixon, 1998). The slip factor (μ) is multiplied against the entering and exiting velocities and can be written as a function of the number of blades, Z_{B}.

$$μ = 1 - \frac{0.63 \cdot π}{{z}_{B}} \qquad ( 11 )$$

Between the impeller and the diffuser vanes, vaneless compression occurs in the interspace and the state changes from 7i to 7. The properties in state 7 can be calculated using the interspace expressions derived earlier. Likewise, when the flow is further slowed and compressed in the vaned diffuser and the state changes from 7 to 8. This change can be modeled as a diffuser using expressions derived in the previous section. Finally, the fluid is collected in the volute casing and discharged at State 9. Typically, this change in state is small and neglected (Dixon, 1998).

Unlike the inward flow radial turbine, the centrifugal compressor does not have variable geometry, and, as such, the implicit models derived at the design conditions are said to be representative at off-design conditions. As a result, the aMoB model set is representative of the aMoB⁺ model set for the compressor. Differences between the aMoB⁺ model set and the control are addressed by adjusting the fluid rotation entering and exiting the impeller with the assumption of negligible pre-whirl and the addition of a slip factor that describes secondary passage flow mixing with the main stream, in addition to other enthalpy loss models described in the literature (Dixon, 1998).

### Explicit Models

When utilized in a real-time performance monitoring role, it is often beneficial to approximate the aMoB⁺ model, which is inherently implicit, as an explicit model. For a fixed diameter radial expander typically used in cryogenic recovery processes, the variables in Eq. 1 can be further reduced to pressure ratio (P_{R}), adiabatic efficiency (η), flow coefficient (\dot{Q}/N), speed ratio (U/C₀), and constrained heat capacity ratio (γ_{C}) using the Buckingham-π theorem.

$$f ( η , \frac{\dot{Q}}{N} , \frac{U}{{C}_{0}} , {P}_{R} , {γ}_{C} ) = 0 \qquad ( 12 )$$

The flow coefficient and speed ratio help to describe the flow regime of the fluid in the expander. The pressure ratio helps to describe the mechanical geometry. The constrained heat capacity ratio can be utilized to describe compositional changes in the gas stream. Unlike most applications, however, cryogenic gas streams typically phase separate in expanders, significantly changing the composition of the vapor phase, and altering its performance. This dynamic behavior is limited by constraining the heat capacity ratio and off-design performance to an operating region exhibiting similar phase separation characteristics.

Any explicit model that satisfies Equation 12 is referred to as the Buckingham-n theorem (BPT) model for an expander. The flow coefficient, speed ratio, and pressure ratio can be parameterized separately by fitting the efficiency response of the aMoB⁺ model to the design curves provided by the manufacturer.

An alternative representation of the BPT expression can be ascertained for a compressor. Unlike the expander, the compressor has a fixed geometry which results in an expression with only 4 parameters: polytropic efficiency (η), polytropic head coefficient (ψₚ), power coefficient, also known as the work or blade loading coefficient (Ψ), and constrained heat capacity ratio (γ_{C}).

ƒ(η,ψₚ,Ψ,γ_{C})=0 (13)

The power coefficient helps to describe the flow regime of the fluid in the compressor, while the polytropic head coefficient helps to describe the mechanical geometry. The constrained heat capacity ratio works in the same manner as for an expander, except that it does not encounter multi-phase flow. As before, the expression in Equation 13 is rearranged, non-dimensionalized, and fitted at off-design conditions using the combined mass, energy, and momentum balances.

### Application

A process information application (PI) was created to communicate with a data historian (data storage and retrieval means in a PI system) for the purpose of utilizing a CPS in a service role. A data flow schematic involving the PI is shown in FIG. 6. The application: (1) reads an XML configuration file, (2) uses that information to call a data historian and captures data of interest, (3) loads the data into CPS system, (4) performs engineering calculations and returns the results, (5) performs analysis calculations using the BPT model, (6) captures the results, and (7) returns the results to the data historian where it can be (8) accessed by a Graphical User Interface (GUI).

### Case Study

To demonstrate the application's capabilities, real-time access to operating data, process flow diagrams, and equipment performance specifications were gathered on a cryogenic gas plant train. This information was used to create an aMoB⁺ model set on a turboexpander, which was then approximated using an empirical BPT model.

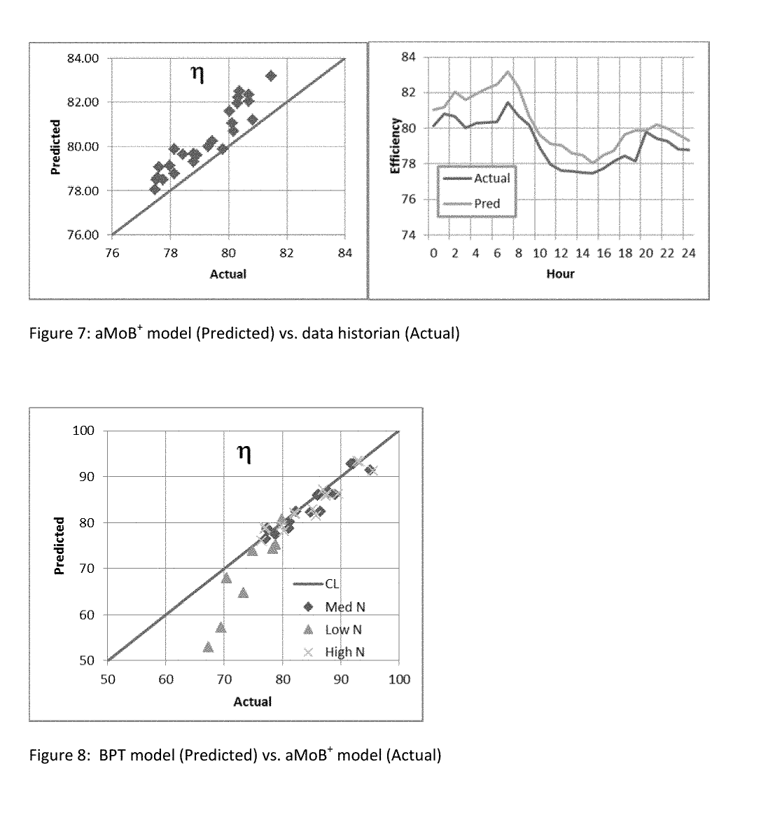

To begin this process, expander performance curves provided by the equipment manufacturer were fit using a fourth order taylor series polynomial model at the design composition and pressure ratio, resulting in BPT predictive expressions for the flow coefficient (\dot{Q}/N) and speed ratio (U/C₀). Next the aMoB was constructed using Equation 3-6 with the stator and diffuser modeled as a nozzle with constant 95% efficiencies. A VAC second order taylor polynomial model using the momentum at state 2i as the dependent variable was developed and combined with the aMoB to create the aMoB⁺ model. Finally, the turbo-machinery momentum model was tested at off-design conditions against real-time data from the PI-Historian. The mean hourly conditions are shown in FIG. 7. The model slightly over-predicted the efficiency, indicating that additional loss models were warranted.

Both the pressure ratio and constrained heat capacity predictive expressions were then developed running scenarios against the turbo-machinery momentum model. Using the concept of a face-centered factorial design, the empirical BPT model 12 was tested against the aMoB⁺ model at high and low off-design conditions of incoming pressure, mass flow rate, composition, and pressure ratio resulting in FIG. 8. The analysis test shows good agreement, with the two exceptions: (1) a region where the two-phase flow enters the rotor and (2) a region of operation where the fluid exits the rotor at an angle and violates one of the assumptions made in the application of turbo-machinery momentum balance. The first exception occurs because the operating composition has again significantly deviated from the design composition. The second exception occurs under low shaft speed, low pressure ratio, and/or high mass flow rate. Under these conditions the kinetic energy of the entering fluid is not completely converted into shaft work and the fluid exits the rotor at an angle, creating rotational flow at the exit. Additional loss mechanisms such as leakage and friction are also more prevalent under these conditions, leading to an underestimation of the efficiency of the system by the turbo-machinery balance. A warning was built into the tool to alarm when this situation occurs and the model was constrained.

The procedure was repeated for the compressor side of the turboexpander. Applicant digitized the compressor performance curves and fit them to Eq. 13 using a fourth order taylor polynomial at the design point, resulting in predictive BPT expressions for the polytropic head coefficient (ψₚ) and blade loading coefficient (Ψ). Next the aMoB⁺ was developed with similar estimations for nozzle efficiency, slip factor, and approach angles as that of the expander. The model was validated at off-design conditions against real-time data from the data historian, resulting in good agreement near the design point and off-design conditions. Using the face-centered factorial design again, the fully parameterized BPT model of 15 was tested against the turbo-machinery model at high and low off-design conditions of incoming pressure, mass flow rate, and composition resulting in good agreement over the range of conditions explored.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. An improved computer system programmed to calculate turbo-machinery operation parameters and performance or computer system programmed to process and display process information, comprising;
incorporating into said computer system(s) Turbo-machine BPT model software expressed in machine readable language that improves the operation of a computer system, wherein the Turbo-machine system is configured in computer readable language to perform the steps:
a) obtain equipment and process design specifications;
b) use design specifications to build an aMoB model of the system;
c) use the aMoB model to develop the parameters for the BPT model;
d) using a design of experiments approach, fit the BPT model against a control set of data from a real or virtual machine;
e) add or adjust the vane angle control model and loss models to the aMoB model to create a aMoB+ model;
f) refit the BPT model to the aMoB+ model;
g) repeat steps 4-6 until a satisfactory model is created.

2. The improved computer system of claim 1 wherein the turbo-machinery whose parameters are calculated comprise inward flow radial turbines and centrifugal compressors

3. The improved computer system of claim 1 wherein the turbo-machinery operating parameters comprise liquid and gas flow rates, temperature and pressure. These are generally controlled by automated control valves and other means.

4. A process for control or monitoring an turbo-machine comprising providing a Turbo-machine BPT model software system expressed in machine readable language wherein the Turbo-machine system is configured in computer readable language to perform the steps:
a) obtain equipment and process design specifications;
b) use design specifications to build an aMoB model of the system;
c) use the aMoB model to develop the parameters for the BPT model;
d) using a design of experiments approach, fit the BPT model against a control set of data from a real or virtual machine;
e) add or adjust the vane angle control model and loss models to the aMoB model to create a aMoB+ model;
f) refit the BPT model to the aMoB+ model; and
g) repeat steps 4-6 until a satisfactory model is created;
utilize the resulting Turbo-machine BPT model to provide monitoring for performance of a specific turbo-machine; or to provide control of operating parameters, control of stator or impeller vanes in the turbo-machine to account for fouling or to indicate need for cleaning, maintenance or replacement.

5. The process of claim 4 wherein the turbo-machine comprise either inward flow radial turbines and centrifugal compressors.

6. The process of claim 4 wherein the turbo-machinery operating parameters comprise liquid and gas flow rates, temperature and pressure that are controlled by automated control valves, a mechanical or electrical activators or other means.

7. An article of manufacture comprising a software program disposed on a non-transitory machine-readable media, which software program comprises executable code to implement a Turbo-machine model for a specific turbo-machine that comprise the steps of:
a) obtain equipment and process design specifications;
b) use design specifications to build an aMoB model of the system;
c) use the aMoB model to develop the parameters for the BPT model;
d) using a design of experiments approach, fit the BPT model against a control set of data from a real or virtual machine;
e) add or adjust the vane angle control model and loss models to the aMoB model to create a aMoB+ model;
f) refit the BPT model to the aMoB+ model;
g) repeat steps 4-6 until a satisfactory model is created.

8. The software program disposed on a non-transitory machine-readable media of claim 8 wherein the non-transitory media comprise computer mechanical and solid state hard drive, flash drives, computer disks (CDs) and DVDs.
